(19) United States
(12) Patent Application Publication
(10) Pub. No.: US 2020/0137867 A1
(43) Pub. Date: Apr. 30, 2020

(54) Automated Consumable Exchangers

(71) Applicant: Hypertherm, inc., Hanover, NH (US)

(72) Inventors: Brandon Mason, Grantham, NH (US); Eric Streit, Lebanon, NH (US)

(21) Appl. No.: 16/668,795

(22) Filed: Oct. 30, 2019

Related U.S. Application Data
(60) Provisional application No. 62/752,606, filed on Oct. 30, 2018.

(51) Int. Cl. H05H 1/38; H05H 1/36

(52) U.S. Cl. CPC H05H 1/38; H05H 1/36

(57) ABSTRACT

A consumable exchanger for a plasma arc material processing system is provided. The consumable exchanger comprises a base portion and a holder shaped to retain at least a portion of a consumable component of a plasma arc torch. The holder is operably connected to the base portion. The consumable exchanger further comprises a driver connected to the holder. The driver is configured to rotate the consumable component relative to at least one of the base portion or the plasma arc torch to perform one of engage the consumable component to the plasma arc torch or disengage the consumable component from the plasma arc torch.

### CROSS REFERENCE TO RELATED APPLICATION

This application claims the benefit of and priority to U.S. Provisional Patent Application No. 62/752,606, filed Oct. 30, 2018, the entire content of which is owned by the assignee of the instant application and incorporated herein by reference in its entirety.

### TECHNICAL FIELD

The present invention generally relates to a consumable exchanger for a plasma arc material processing system.

### BACKGROUND

Thermal processing torches, such as plasma arc torches, are widely used in the heating, cutting, gouging and marking of materials. A plasma arc torch generally includes a set of consumable components comprising, for example, an electrode, a nozzle having a central exit orifice mounted within a torch body, electrical connections, passages for cooling, and passages for arc control fluids (e.g., plasma gas). Optionally, a swirl ring is employed to control fluid flow patterns in the plasma chamber formed between the electrode and the nozzle. In some torches, a retaining cap can be used to maintain the nozzle and/or swirl ring in the plasma arc torch. In operation, the torch produces a plasma arc, which is a constricted jet of an ionized gas with high temperature and sufficient momentum to assist with removal of molten metal.

Consumable changes for a plasma arc torch in a plasma processing system need to be regularly performed and are generally accomplished manually by human operators. An operator can initiate a change of a consumable for a plasma arc torch when, for example, the torch needs to be used in a different cutting process or the consumable reaches the end of its useful life. Such a decision can be made by the processing system or the operator, or as a preventative measure. In any case, the final evaluation for consumable change and the actual change is made by the operator who needs to be present and knowledgeable about the processing system, so that the consumable change can be accomplished in a timely and accurate manner to reduce downtime and/or scrap generation. Currently, these consumable changes are manually performed by an operator and/or a technician.

To avoid human errors and improve efficiency during consumable change operations, there is a need for automated exchanger systems that can manage consumable installation and removal for plasma arc torches with minimal human intervention.

### SUMMARY

The present invention features automated consumable exchanger systems that are configured to accomplish full installation and removal of consumable components for a plasma arc torch with minimal (e.g., without) human intervention. Benefits of the present invention include automated consumable engagement and disengagement with enhanced accuracy, consumable utilization and cut quality while reducing human errors during the exchange process, thereby improving overall safety and output by minimizing human involvement. In some embodiments, because the automated consumable exchanger systems of the present invention are able to automatically determine when a consumable component of a plasma arc torch needs to be changed (e.g., due to end of life considerations or changes in processing needs), the torch's operating duration and versatility is optimized, such that the torch can be used in many different cutting processes with improved life performance. Further, the automated consumable exchanger systems of the present invention are able to simplify torch component installation and removal with fewer human inputs.

The present invention, in one aspect, features a consumable exchanger for a plasma arc material processing system. The consumable exchanger comprises a base portion and a holder shaped to retain at least a portion of a consumable component of a plasma arc torch. The holder is operably connected to the base portion. The consumable exchanger further comprises a driver connected to the holder. The driver is configured to rotate the consumable component relative to at least one of the base portion or the plasma arc torch to perform one of engage the consumable component to the plasma arc torch or disengage the consumable component from the plasma arc torch.

In some embodiments, the base portion of the consumable exchanger is configured to be attached to a material processing table. In some embodiments, the consumable component is a cartridge that encapsulates two or more individual plasma arc torch consumables. In some embodiments, the consumable component is air cooled.

In some embodiments, the driver of the consumable exchanger is substantially pneumatic such that rotation by the driver is activated by a gas flow. In some embodiments, the driver is substantially electrical such that rotation by the driver is powered by electrical energy. In some embodiments, a rotation of the driver is no more than about 180 degrees to engage or disengage the consumable component.

In some embodiments, the consumable exchanger further comprises a detector operably connected to the driver to detect a presence of the consumable component in the holder prior to rotation. In some embodiments, the driver is adapted to rotate in a first direction to engage the consumable component to the torch if the detector detects the consumable component in the holder prior to the rotation, and the driver is adapted to rotate in a second direction opposite of the first direction to disengage the consumable component from the torch if the detector does not detect the consumable component in the holder prior to the rotation.

In some embodiments, the consumable exchanger further includes a communication module in electrical communication with a controller of the material processing system. The driver is adapted to rotate in a first direction to engage the consumable component to the torch or in a second direction opposite of the first direction to disengage the consumable component from the torch based on instructions received from the controller via the communication module. In some embodiments, the consumable exchanger further comprises a reader configured to read information stored in a radio-frequency identification (RFID) tag coupled to the consumable component. The information comprises a life characteristic of the consumable component. The reader can be configured to transmit the life characteristic of the consumable component to the controller of the material processing system. The reader can be coupled to the holder.

In some embodiments, the holder of the consumable exchanger is shaped to retain a distal end of the consumable component. In some embodiments, the holder comprises a cup or a gripper with a plurality of claws. In some embodiments, the holder comprises an interface with at least one keyed feature configured to matingly engage a complementary keyed feature of the consumable component for retaining the consumable component during the engagement or disengagement.

In another aspect, the present invention features a computer-implemented method for automatically installing a consumable to a tip of a plasma arc torch that is operably connected to a plasma cutting system. The method includes receiving, by a computing device, (i) data related to a desired operation and (ii) information related to a plurality of consumables, including a performance characteristic of each consumable. The plurality of consumables are disposed in respective ones of a plurality of consumable exchangers. The method also includes selecting, by the computing device, a suitable consumable from the plurality of consumables, where the suitable consumable has a performance characteristic compatible with the desired operation. The method further includes positioning, by the computing device, a torch for engagement with the suitable consumable, and actuating, by the computing device, the consumable exchanger corresponding to the suitable consumable to install the suitable consumable onto a tip of the torch.

In some embodiments, the method further comprises actuating, by the computing device, a separate consumable exchanger to remove an unsuitable consumable from the torch prior to actuating the consumable exchanger to install the suitable consumable onto the torch. In some embodiments, the method further comprises rotating, by the consumable exchanger, the suitable consumable onto the tip of the torch to install the suitable consumable.

In some embodiments, selecting the suitable consumable comprises the computing device determining that the suitable consumable has sufficient remaining life to perform the desired operation based on the performance characteristic of the suitable consumable.

In some embodiments, the computing device is configured to centrally coordinate the automatic installation of the consumable onto the tip of the plasma arc torch without receiving a direction from the plurality of consumable exchanger.

In some embodiments, the computing device receives the information related to each of the plurality of consumables from a radio-frequency identification (RFID) tag attached to each consumable. In some embodiments, the method further comprises automatically reading, by at least one RFID reader, the information related to the plurality of consumables from the RFID tags attached to the corresponding ones of the plurality of consumables and transmitting, by the at least one RFID reader, the information to the computing device. In some embodiments, the at least one RFID reader is a handheld reader. In some embodiments, the at least one RFID reader comprises a plurality of RFID readers coupled to corresponding ones of the plurality of consumable exchangers.

In yet another aspect, the present invention features a material processing system that includes a plurality of consumable exchangers each comprising a holder shaped to retain and install a consumable, and a computing device in electrical communication with the plurality of consumable exchangers. The computing device includes an input module configured to receive (i) data related to a desired operation and (ii) information related to a plurality of possible consumables, including a performance characteristic of each possible consumable. The plurality of possible consumables are disposed in respective ones of the plurality of consumable exchangers. The computing device also includes a decision module configured to select a suitable consumable from the plurality of possible consumables, where the suitable consumable has a performance characteristic compatible with the desired operation. The computing device further includes a torch locator configured to select a torch for engagement with the suitable consumable, and an actuation module configured to instruct the consumable exchanger corresponding to the suitable consumable to install the suitable consumable onto a tip of the torch.

In some embodiments, the material processing system further comprises a plurality of RFID tags coupled to corresponding ones of the possible consumables. The plurality of RFID tags are configured to store the performance characteristics of the respective possible consumables. The material processing system can further comprise at least one RFID reader configured to read the performance characteristics from the RFID tags and transmit the performance characteristics to the input module.

In yet another aspect, the present invention features a method for installing a consumable cartridge onto a tip of a plasma arc torch in a plasma cutting system. The consumable cartridge includes at least an electrode and a swirl ring. The method includes loading the consumable cartridge in a holder of a consumable exchanger, where the holder is configured to retain at least a portion of the consumable cartridge. The method also includes aligning, by a computing device, the tip of the plasma arc torch with the consumable cartridge in the consumable exchanger to achieve an aligned position, and driving the plasma arc torch downward along a vertical direction toward the consumable exchanger in the aligned position. The method further includes rotating, by the consumable exchanger, the consumable cartridge relative to the plasma arc torch to thread the consumable cartridge onto the tip of the torch.

In some embodiments, the method further includes moving, by the consumable exchanger, the consumable cartridge upward along the vertical direction during the rotation to thread the consumable cartridge onto the tip of the torch.

In some embodiments, the driving of the plasma arc torch downward initiates the translation of the consumable exchanger in a lateral plane to position the consumable exchanger under the plasma arc torch.

In some embodiments, the consumable exchanger retains the at least a portion of the consumable cartridge via a keyed interface comprising a keyed feature of the consumable exchanger matingly engaging a corresponding keyed feature of the consumable cartridge. The consumable exchanger can include an even number of keyed features that are located symmetrically around a circumference of the consumable exchanger. The consumable exchanger can apply a torque substantially evenly around the circumference during the rotation to thread the consumable cartridge onto the tip of the plasma arc torch.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 shows exemplary consumable exchangers for a plasma arc material processing system, including a consumable exchanger configured to remove a consumable component from the tip of a plasma arc torch and a separate consumable exchanger configured to install a consumable onto the tip of a plasma arc torch, according to some embodiments of the present invention.

FIG. 2 shows an exemplary consumable cartridge having a keyed feature configured for retention by at least one of the consumable exchangers of FIG. 1, according to some embodiments of the present invention.

FIG. 3 shows another exemplary consumable cartridge having a different keyed feature configured for retention by the holder of at least one of the consumable exchangers of FIG. 1, according to some embodiments of the present invention.

FIG. 4 shows an exemplary interface formed by the keyed cartridge of FIG. 3 and a corresponding holder, according to some embodiments of the present invention.

FIG. 5 shows a portion of an exemplary material processing system that includes at least one consumable exchanger for consumable removal and multiple consumable exchangers forming an exchanger array, according to some embodiments of the present invention.

FIG. 6 shows an exemplary operation executable on the material processing system of FIG. 5, according to some embodiments of the present invention.

FIG. 7 shows an exemplary block diagram of a centrally-controlled material processing system with automated consumable exchanging capabilities, according to some embodiments of the present invention.

FIG. 8 shows an exemplary configuration of the central controller of the material processing system of FIG. 7, according to some embodiments of the present invention.

FIG. 9 shows an exemplary process executable by the central controller of FIG. 8 for initiating automatic consumable component installation in the material processing system of FIG. 7, according to some embodiments of the present invention.

FIG. 10 shows an exemplary process by a consumable exchanger of the present invention for installing a consumable cartridge onto a tip of a plasma arc torch in a plasma cutting system with automated consumable exchanging capabilities, according to some embodiments of the present invention.

### DETAILED DESCRIPTION

In general, the material processing systems described herein are configured to automatically install a consumable component onto or remove a consumable component from the tip of a plasma arc torch. In the context of the present invention, a consumable component can be an individual plasma arc torch consumable, such as an electrode, a nozzle, a shield or a swirl ring. A consumable component can also be a consumable cartridge of a plasma arc torch that encapsulates two or more of the individual plasma arc torch consumables. The consumable cartridge can be a unitary component where the individual components of the cartridge are not individually serviceable or disposable. Thus, if one component of the consumable cartridge needs to be replaced, the entire cartridge is replaced. In some embodiments, the consumable cartridge is a “single use” cartridge, where the cartridge is replaced after any of the components thereof reaches the end of its service life rather than repairing and replacing the individual consumables. In some embodiments, the consumable component that can be installed or removed by the material processing systems of the present invention is a set of cupped/stacked individual torch consumables. In some embodiments, the consumable component is air cooled when installed onto the plasma arc torch.

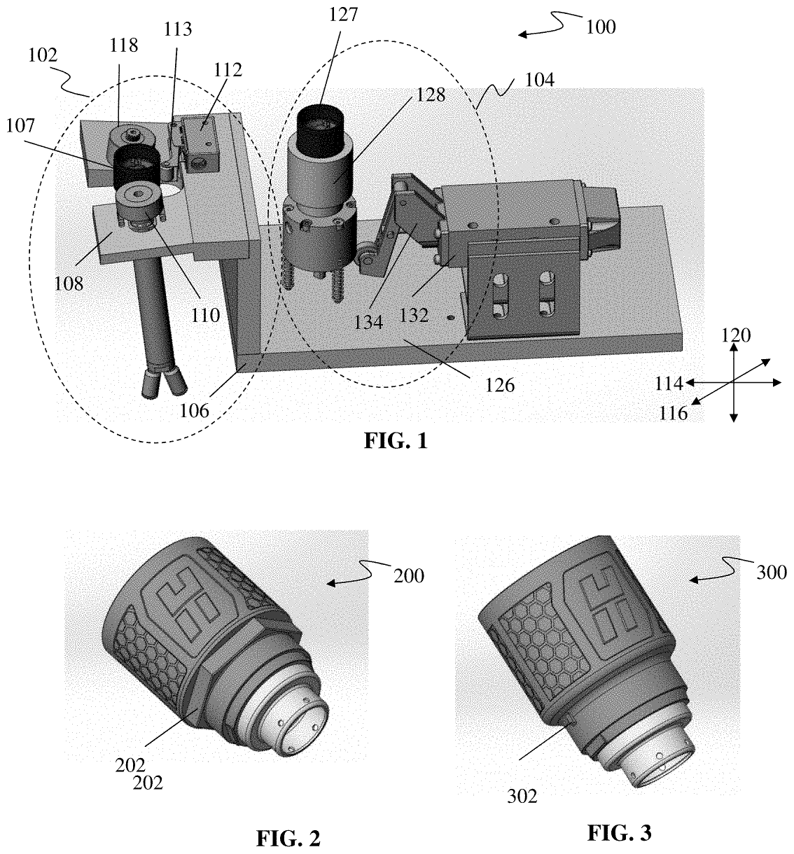

FIG. 1 shows exemplary consumable exchangers for a plasma arc material processing system 100 including a consumable exchanger 102 configured to remove a consumable component from the tip of a plasma arc torch and a separate consumable exchanger 104 configured to install a consumable onto the tip of a plasma arc torch, according to some embodiments of the present invention. As shown, the consumable exchanger 102 for consumable removal includes a base portion 106 and a holder 108 operably connected to the base portion 106. The base portion 106 is configured to connect the exchanger 102 to a material processing table or provide a stand-alone stable base for consumable exchanging operations. Prior to consumable removal, a plasma arc torch (not shown), which includes a consumable component 107 to be removed, is positioned adjacent to the holder 108. In some embodiments, the holder 108 is shaped and configured to grab and retain at least a portion of the consumable component 107, such as the distal end of the consumable component 107, where the distal end is defined as the end that is closest to a workpiece when the torch is processing the workpiece. In some embodiments, the holder 108 is shaped and configured to receive the plasma arc torch as the torch slides laterally into the exchanger 102 along a lateral plane (as defined by the x-axis 114 and the y-axis 116). As shown, the holder 108 has a u-shaped opening for receiving the consumable component 107 of the plasma arc torch, thereby engaging the torch to the exchanger prior to removal. Other shapes and configurations for the holder 108 are possible, as understood by a person of ordinary skill in the art.

The consumable exchanger 102 also includes a driver 112 in electrical communication with the holder 108. The driver 112 is generally configured to power rotation of the consumable component 107, or the holder 108 while the holder 108 retains the consumable component 107. Specifically, the driver 112 is adapted to rotate the holder 108 and/or the consumable component 107 relative to at least one of the base portion 106 or the plasma arc torch in a clockwise or counterclockwise direction along the lateral plane (as defined by the x-axis 114 and the y-axis 116) to remove the consumable component from the tip of the plasma arc torch. In some embodiments, during rotation, the base portion 106 and the plasma arc torch remain substantially stationary while the holder 108 and/or the consumable component 107 rotate. After removal by the consumable exchanger 102, the removed consumable component 107 can fall away from the torch for disposal or collection for reuse.

The driver 112 can initiate the removal process (i.e., activating rotation of the holder 108 and/or the consumable component 107) based on the location of the plasma arc torch relative to the consumable exchanger 102. For example, the driver 112 does not initiate rotation until the consumable component to be removed 107 is seated within the holder 108. In some embodiments, a detector 113 is operably connected to the driver 112 to detect the presence of the consumable component 107 in the holder 108 prior to rotation for disengagement. The detector 113 can be disposed in or on the holder 108 and in the form of an electrical sensor or a mechanical switch that is activated when pressed against by the consumable component 107. In some embodiments, initiation of the driver 112 to rotate the holder 108 and/or the consumable component 107 is triggered by a central computing system, instead of decided locally by the exchanger 102, as described below.

The consumable exchanger 102 can employ various mechanisms to rotate the consumable component 107 and/or the holder 108. In some embodiments, the driver 112 for the consumable exchanger 102 is in electrical communication with two rollers 118, 110, at least one of which can be driven to rotate in the x-y plane. The consumable component 107 is held in place by the holder 108 between the rollers 118, 110 and in physical contact with the rollers 118, 110 such that the rollers 118, 110 can rotate the consumable component 107 when actuated by the driver 112. For example, during rotation of the consumable component 107 for removal from the plasma arc torch, one of the rollers 118 can remain idle (i.e., no rotational movement) while the other roller 110 can be driven to spin in the x-y plane so as to cause the consumable component 107 to spin in the same direction, thereby removing the consumable component from the tip of the plasma arc torch. In some embodiments, more or fewer rollers can be used to accomplish the removal task. In some embodiments, both rollers 118, 110 can spin in the same direction to accomplish the removal task.

FIG. 1 also shows a separate consumable exchanger 104 located adjacent to the consumable exchanger 102, where the consumable exchanger 104 is configured to install a consumable component 127 onto the tip of a plasma arc torch. The consumable exchanger 104 for consumable installation has a base portion 126 and a holder 128 operably connected to the base portion 126 via a driver 132. The base portion 126 can share the same platform as the base portion 106 for the removal exchanger 102. Alternatively, the base portion 126 can be separate from the base portion 106 such that the exchangers 102, 104 are independently movable relative to each other. The holder 128 is shaped and configured to retain at least a portion of the pre-loaded consumable component 127, such as the distal end of the consumable component 127, for installation onto to the tip of a plasma arc torch (not shown).

In some embodiments, the consumable exchanger 104 further includes a lifter (not shown) configured to lift the consumable component 127 upward in the vertical direction 120 during consumable installation by rotation. The lifting motion by the lifter to meet the torch tip of the plasma arc torch can occur substantially simultaneously as the plasma arc torch is lowered toward the consumable exchanger 104. The lifter can be in the form of a mechanical arm operably connected to the driver 132.

Similar to the driver 112, the driver 132, which is in electrical communication with the holder 128, is configured to rotate the consumable component 127 and/or the holder 128 relative to at least one of the base portion 126 or the plasma arc torch in a clockwise or counterclockwise direction along the x-y plane to thread the consumable component onto the tip of the plasma arc torch. In some embodiments, the rotation by the driver 132 to install a consumable component onto a torch is in a direction opposite of the direction of rotation by the driver 112 to remove a consumable component from a torch.

Similar to the driver 112, the driver 132 can initiate the installation process (i.e., activate rotation of the consumable component 127 and/or the holder 128) based on the location of the plasma arc torch relative to the consumable exchanger 102. For example, the driver 132 is configured to not initiate rotation until the plasma arc torch is positioned above the holder 108 and is applying a downward force relative to the exchanger 104 along the vertical direction 120 for engagement with the pre-loaded consumable component 127. In some embodiments, a detector 134 is operably connected to the driver 112 so that the downward force experienced by the holder 128 triggers detection by the detector 134 the presence of the plasma arc torch. In some embodiments, initiation of the driver 132 to rotate the consumable component 127 and/or the holder 128 is triggered by a central computing system, instead of decided locally by the exchanger 104, as described below in detail.

The consumable exchanger 104 can also employ various mechanisms to rotate the consumable component 127 and/or the holder 128. In some embodiments, the consumable exchanger 104 uses one or more rollers, such as the rollers 118, 110, described above with respect to the exchanger 102, to rotate the consumable component 127 for installation onto a plasma arc torch. In some embodiments, the holder 128 is in the form of a cup, such as a collet, that includes an O-ring in the inner circumference of the cup designed to provide a tight and tactile grip on the consumable component 127 to be installed onto a plasma arc torch. Once the torch is lowered onto the consumable exchanger 104, the driver 132 activates rotation of the cup/collet 128, which in turn rotates the consumable component 127 therein, to thread the consumable component 127 onto the tip of the torch. In this configuration, no rollers are needed. In some embodiments, the consumable exchanger 102 accomplishes consumable removal using the same cup/collet configuration of the exchanger 104, thus obviating the needs for the rollers 118, 110.

In some embodiments, rotation of the consumable components 107, 127 and/or the holders 108, 128 by the respective drivers 112, 132 is no more than about 180 degrees to disengage or engage the consumable component, respectively. In some embodiments, each of the consumable components 107, 127 and/or the holders 108, 128 is rotated between about 150 and about 280 degrees to disengage or engage the consumable component. In some embodiments, the degree of rotation is preprogrammed such that the drivers 112, 132 cease rotation after the rotational degree is achieved. In some embodiments, timing and/or degree of rotation is dictated by a central control system as described in detail below.

In some embodiments, the driver 112 or the driver 132 is substantially pneumatic such that it activates rotation by pressure from a gas flow. The gas flow can be sourced from a gas supply (not shown) of the plasma arc system, compressed gas supply (e.g., shop air) proximate to the plasma arc system, and/or the plasma arc torch from which a consumable component is to be removed or onto which a consumable component is to be installed. Alternatively, the driver 112 or the driver 132 is substantially electrical such that it activates rotation via electrical energy, which can also be supplied by the torch itself, from a separate power supply (not shown) and/or form an outlet/electrical supply.

In general, the holders 108, 128 can use the same or different mechanisms for retaining a consumable component for removal or installation. In some embodiments, each of the holders 108, 128 is configured as a cup (e.g., collet) with an optional O-ring disposed in the inner circumference of the cup to provide a tight, tactile grip on the consumable component, as described above with respect to the installation exchanger 104. In some embodiments, each of the holders 108, 128 is a position guide to firmly clamp the consumable component in position, as described above with respect to the removal exchanger 102. In some embodiments, each of the holders 108, 128 is a gripper with two or more claws configured to retain a tight grip on the consumable component. The gripper can be configured to grip the consumable component at the same locations around the component for both installation and removal.

In some embodiments, each of the holders 108, 128 has a complex-shaped circumference configured to form a keyed interface with a corresponding complex-shaped circumference of the consumable component in order to retain/orient the consumable component and/or drive rotation of the consumable component. FIG. 2 shows an exemplary consumable cartridge 200 having a keyed feature configured for retention by the holder of at least one of the consumable exchangers 102, 104 of FIG. 1, according to some embodiments of the present invention. As shown, the consumable cartridge 200 has a complex-shaped (e.g., hexagonal) band 202 of flat surfaces disposed at an outer circumference of the cartridge body, where the band 202 is adapted to form a keyed interface with a complementary complex-shaped (e.g., hexagonal) inner circumference of the holder 108, 128 in the corresponding exchanger 102, 104. Such a keyed interface allows the holder 108, 128 to tightly retain the consumable component during rotation for consumable engagement or disengagement.

FIG. 3 shows another exemplary consumable cartridge 300 having a different keyed feature configured for retention by the holder of at least one of the consumable exchangers 102, 104 of FIG. 1, according to some embodiments of the present invention. The keyed feature of the consumable cartridge 300 comprises one or more notches 302 (e.g., one or more protrusions) disposed at an outer circumference of the cartridge 300, where each notch 302 is adapted to form a keyed interface with a complementary-shaped slot on the inner circumference of the holder 108, 128 in the corresponding exchanger 102, 104. In one example, the cartridge 300 includes a plurality of notches 302 configured to form a keyed interface with a plurality of slots in the corresponding exchangers 102, 104.

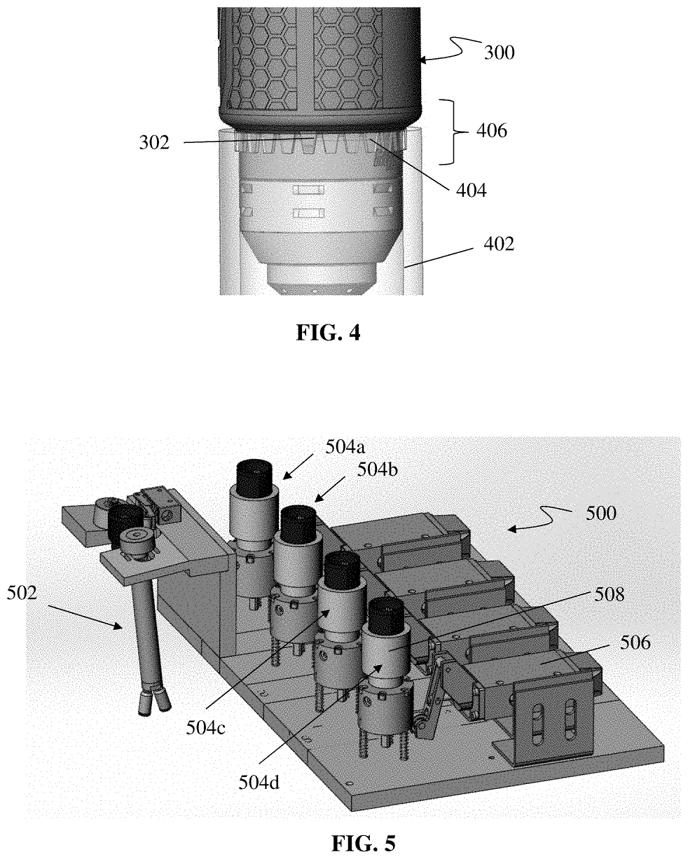

FIG. 4 shows an exemplary interface 406 formed by the keyed cartridge 300 of FIG. 3 and a corresponding holder 402, which can be the holder 108 in the consumable exchanger 102 or the holder 128 in the consumable exchanger 104 of FIG. 1, according to some embodiments of the present invention. As shown, each of the one or more notches 302 of the cartridge 300 is adapted to fit into one of the slots 404 in the holder 402. In some embodiments, multiple slots 404 can be spaced around an inner circumference of the holder 402 such that each of the notches 302 can be easily retained by the holder 402 via any one of the slots 404 without the need to position the cartridge 300 at a specific radial orientation with respect to the holder 402.

In some embodiments, the keyed features on the consumable component and the holder are symmetrically and/or evenly spaced around the circumferences of the respective devices such that an even amount of torque is applied by the corresponding consumable exchanger to remove or install the consumable. For example, with respect to the consumable cartridge 300 of FIGS. 3 and 4, at least two notches 302 can be evenly distributed around the outer circumference of the cartridge 300. In addition, the slots 400 of the holder 402 can be even distributed around the inner circumference of the holder 402. Such configurations of the cartridge 300 and the holder 402 allow the exchanger to apply a substantially uniform torque around the cartridge 300 during rotation to engage or disengage the cartridge 300 relative to a torch. In some embodiments, an even number of keyed features are located symmetrically around the respective consumable component and holder to facilitate uniform torque application.

In another aspect, one or more of the consumable exchangers 102, 104 are incorporated in a larger material processing system to facilitate automatic and serialized consumable installation and removal operations. FIG. 5 shows a portion of an exemplary material processing system 500 that includes at least one consumable exchanger 502 for consumable removal and multiple consumable exchangers 504a-d forming an exchanger array, according to some embodiments of the present invention. In some embodiments, each of the consumable exchangers 504a-d is configured for consumable installation only, same as the exchanger 104 of FIG. 1. In some embodiments, each of the consumable exchangers 504a-d is configured to perform both consumable removal and installation. Thus both the removal and installation functions are integrated in a single exchanger unit. In general, each integrated exchanger 504 can have the same physical configuration as the exchanger 102 for consumable removal or the exchanger 104 for consumable installation. The main difference is that the driver 506 of the integrated exchange 504 can be actuated to rotate the holder 508 and/or the consumable component in both clockwise and counterclockwise directions for consumable removal and installation. This versatility allows the integrated exchanger 504 to repeatedly and rapidly exchange consumables with minimal operator involvement. As an example, each of the consumable exchangers 504a-d can be preloaded with a different consumable component ready for installation. Once the removal exchanger 502 removes a consumable component (e.g., a cartridge for gouging) from a plasma arc torch, the torch can be moved to a desired exchanger 504 for installation of a consumable component that is suitable for a next desired processing task (e.g., a cartridge for cutting or marking). Thus, the system 500 enables a torch to repeatedly switch among different processes (e.g., cutting and gouging) without human involvement. As understood by a person of ordinary skill in the art, the system 500 can be configured to include any number of removal exchangers 102, installation exchangers 104 and/or integrated exchangers 504 in any desired arrangement.

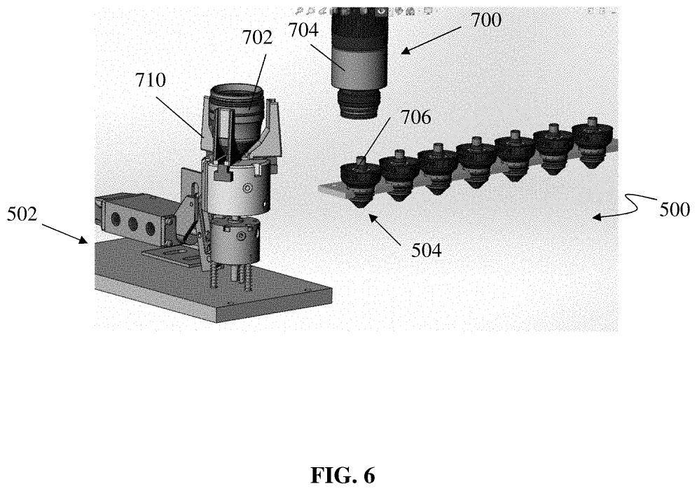

FIG. 6 shows an exemplary operation executable on the material processing system 500 of FIG. 5, according to some embodiments of the present invention. For this operation, each of the exchanger 502 and the array of exchangers 504 is configured as an integrated exchanger, capable of both consumable installation and removal. The system 500 is first provided with a plasma arc torch 700 that requires installation of a consumable cartridge 706 and/or a consumable cap 702. The plasma arc torch 700 is first translated to the exchanger array 504 and lowered into the holder of a specific exchanger with a desired cartridge 706 preloaded thereon for installation of the cartridge 706 onto the torch 700. In particular, the torch body 704 is lowered into the holder 508 (as identified in FIG. 5) of the exchanger 504 that holds the desired cartridge 706. Thereafter, the exchanger 504 can rotate the cartridge 706 relative to the torch body 704 to thread the cartridge 706 onto the torch's tip. Alternative, engagement and disengagement between the torch body 704 and the cartridge 706 is in a push-pull manner, in which case a downward vertical force is applied on the torch body 704 against the desired cartridge 706 to install the cartridge 706. After the installation of the cartridge 706, the torch 700 is lifted upward from the exchanger 504 and translated to the exchanger 502 for installation of the cap 702 that is preloaded on the exchanger 502. In particular, the torch 700, which includes the newly installed cartridge 706, is lowered into the holder 710 of the exchanger 502, where the holder 710 can be in the form of a claw configured to grab and retain the cap 702 and rotate the cap 702 relative to the torch 700 to engage the cap 702 with the cartridge 706.

If a new cartridge and cap combination is desired, the same system 500 can also be utilized to perform the consumable exchange. For example, the system 500 can first use the exchanger 502 to disengage the cap 702 of the torch by lowering the torch 700 into the holder 710 for removal of the cap 702. Specifically, the holder 710 grabs and retains the cap 702 of the torch 700 and rotates the cap 702 relative to the remaining portion of the torch 700 to disengage the cap 702 from the torch 700. The holder 710 can retain the removed cap 702 for subsequent installation needs. After removal of the cap 702, the plasma arc torch 700 is lifted upward from the exchanger 502 and translated to an exchanger 504 with an empty holder (not shown) for removal of the exposed cartridge 706 from the tip of the torch 700. For example, the holder of the exchanger 504 can retain the exposed cartridge 706 and remove the cartridge 706 from the torch via rotation of the cartridge 706 relative to the torch body 704. Alternatively, in a push-pull configuration, an upward vertical force can be applied to torch body 704 to separate the cartridge 706 from the torch body 704 while the cartridge 706 is retained by the holder. The torch 700 is then lifted from the exchanger and translated to another exchanger of the exchanger array 504 that has a desired cartridge 706 preloaded thereon for installation of the new cartridge 706 onto the torch 700. The torch 700 can then be directed to the exchanger 502, which has retained the cap 702 that was previously removed from the torch 700. The exchanger 502 can rotatably install the cap 702 onto the new cartridge 706 of the torch 700. This exemplary process illustrates the ease with which a stack of consumable components can be exchanged in a torch to suit different processing needs, such as switching from a cutting process to a marking process. In general, the exemplary material processing system 500 of FIGS. 5 and 6 can increase time between operator intervention for consumable change-out, optimize consumable consumption and enable each plasma arc torch to perform a multitude of varied tasks (e.g., cutting, gouging, marking or and flush-cutting).

FIGS. 1, 5 and 6 show the consumable exchangers 102, 104, 502, 504 being located proximate to each other in their respective systems, which is a setup that facilitates quick consumable changes. However, in other embodiments, the consumable exchanges of a material processing system are not located close to each other. Instead, at least one of the exchangers in each system can be mobile and dynamically translated to the plasma arc torch for consumable removal or installation. In some embodiments, the consumable exchangers of each system are coupled to a material processing table, such as a computer numerical controlled (CNC) table or a X-Y table for material processing. For example, the base portion of each exchanger can be attached to the material processing table. In operation, a controller can move a plasma arc torch to the suitable exchanger at a specific location for consumable removal or installation.

In some embodiments, each consumable exchanger can activate or deactivate holder rotation based on a local sensor configured to sense the presence of the plasma arc torch to which a consumable component is to be installed or the presence of the consumable component to be removed, as described above with respect to FIG. 1. In another aspect, the material processing systems of the present invention enable intelligent central control of consumable exchanging for plasma arc torches, thereby obviating the need of individual exchangers to decide whether to install or remove a consumable component or when to initiate the installation/removal process. Therefore, in these centrally controlled systems, local detectors do not need to be installed in the individual exchangers. However, in some embodiments, the central controller can still use the signals from the local detectors to make global consumable exchanging decisions. Further for integrated exchangers, such as the exchangers 504a-d of FIGS. 5 and 6, a central control system can communicate with each exchanger to initiate an installation or removal process.

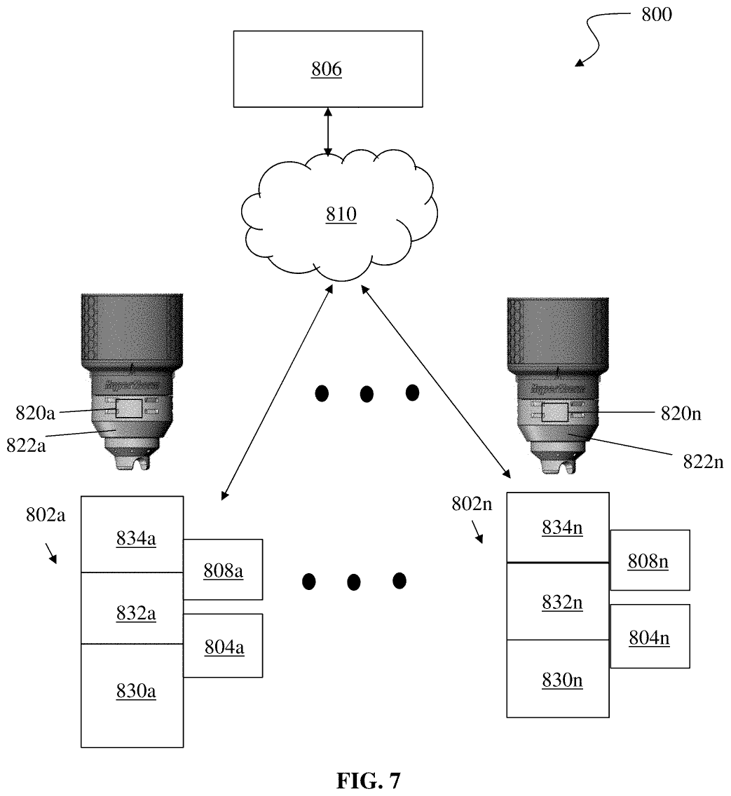

FIG. 7 shows an exemplary block diagram of a centrally-controlled material processing system 800 with automated consumable exchanging capabilities, according to some embodiments of the present invention. As shown, the system 800 includes a central controller 806 communicatively connected to one or more consumable exchangers 802 via a communication network 810. The communication network 810 can be an IP network, such as a LAN, WAN, cellular network or the Internet. In other embodiments, communications occur over network protocols other than Internet Protocol (IP), such as infrared transmission systems, Blue Tooth Networks or Personal Area Networks (PANs). In yet other embodiments, the network 810 provides wired connections among the various devices in the system 800.

Each exchanger 802 can be an exchanger 102 for consumable removal, an exchanger 104 for consumable installation, or an integrated exchanger 504 that combines both removal and installation functions. Generally, each exchanger 802 includes a base portion 832, a holder 834 shaped to receive and/or retain a consumable component 822 to be installed to or removed from an adjacent plasma arc torch, and a driver 830 for rotating the holder 832 and/or the consumable component 822 for consumable installation or removal. As shown, each exchanger 802 also includes a communication module 804 in electrical communication with the central controller 806 via the communication network 810. The communication module 804 can be located in or on the exchanger 802 or remote from, but adjacent to the exchanger 802. The communication module 804 is configured to receive instructions from the central controller 806 regarding timing and direction of rotation by the driver 830 to perform either a removal or installation task. For example, the central controller 806 can instruct the exchanger 802 to rotate its holder 834 and/or the consumable component 822 in a first direction (e.g., counterclockwise direction) to engage/install the consumable component 822 onto the torch or in a second direction opposite of the first direction (e.g., clockwise direction) to disengage/remove the consumable component 822 from the torch.

In an example of consumable installation, when the torch tip is lowered toward the exchanger 802 that holds the consumable component to be installed, the proximal end of the consumable component can include a raised/protrusion portion configured to trigger (e.g., depress) a consumable sensing switch on the distal end of the torch tip. This activation of the sensing switch transmits an activation signal to the central controller 810 via the communication module 804, which prompts the central controller 810 to instruct the driver 830 of the exchanger 802 (again via the communication module 804) to commence rotation in a certain direction to start installation of the consumable component onto the torch tip. The controller 806 can also instruct the exchanger to initiate consumable installation based on one or more of: detection of the torch tip by a local detector on the exchanger (e.g., the local detector 134 of FIG. 1), analysis of data from an RFID tag attached to the consumable component to be installed, or verification of the location of the torch relative to the exchanger to ensure that the torch is positioned for installation. Similarly, for consumable removal, the controller 806 can instruct the exchanger to initiate removal of a consumable component from a torch based on one more of: detection of the torch by a local detector on the exchanger (e.g., the local detector 113 of FIG. 1), analysis of data from an RFID tag attached to the consumable component to be removed, or verification of the location of the torch relative to the exchanger to ensure that the torch is adjacent to the exchanger.

In some embodiments, at least one radio-frequency identification (RFID) tag 820 is attached to each of the consumable components 822 in the system 800, such as coupled to the body of each consumable component 822 or located within (e.g., integrated within) the body of each consumable component 822. Hence, the system 800 can include multiple RFID tags 820 assigned to respective ones of the consumable components 822 if there are multiple consumable components 822 in the system 800. Each of these consumable components 822 is either waiting to be installed into a torch or is removable from a torch. In the case of installation, the consumable component 822, including the attached RFID tag 820, is loaded onto the holder 834 of an exchanger. In the case of removal, the consumable component 822, including the attached RFID tag 820, is still coupled to the plasma arc torch.

Each RFID tag 820 is configured to store information about the corresponding consumable component 822, such as information related to at least one performance characteristic of the consumable component 822. The performance characteristic can comprise a life characteristic of the consumable component 822 to indicate, for example, a measure of the useful life remaining in the consumable component 822. Exemplary life characteristics include information related to one or more previous uses of the consumable component 822. For example, the information can include information relating to the frequency of use (e.g., how many cutting or welding operations for which the consumable component 822 has been used over a given time), relating to a number (e.g., a total number) of cutting cycles for which the consumable component 822 has been used, or relating to a time duration of the previous use of the consumable component 822. The performance characteristic can also include an identification of the consumable component 822, such as the type, serial number, and/or manufacturer of the consumable component 822.

In some embodiments, the performance characteristics encoded to an RFID tag 820 includes information at the time of manufacture of the corresponding consumable component 822 as well as during the lifetime of the consumable component 822, such as after each consumable use, installation or removal. Such information can include the date, time and location of consumable use, installation or removal, any abnormalities detected during use, installation or removal and/or consumable conditions after use, installation or removal so that a log can be created by the controller 806 to predict a failure event or end-of-life event associated with the consumable component.

In some embodiments, the performance characteristics encoded to an RFID tag 820 specify suitable operating parameters for the consumable component 822. Exemplary operating parameters include a cutting program, an electrical current (e.g., ignition or cutting current) or gas (e.g., plasma or shield gas) ramping profile, set up values for the thermal processing system, cut cycle or life data of the torch of consumables, gas flow rates (e.g., ignition or cutting gas flow rates), gas types (e.g., gas selection instructions), pierce delay time, timing parameters, set points, error conditions, thresholds, or a coordination of multiple parameters. The performance characteristics can also record operating parameters during previous uses of the consumable component 822, and in some cases, information relates to a failure or error of the consumable component during the previous uses. Additional performance data that can be encoded to an RFID tag 802 of a consumable component 822 are described in U.S. Patent Application No. 2013/0264317 assigned to Hypertherm Inc., of Hanover, N.H., the contents of which are hereby incorporated by reference in its entirety.

In some embodiments, each RFID tag 802 is both readable and writable as well as rewritable such that new data can be written to the RFID tag 802 after the initial writing of data (e.g., with or without deleting or overwriting other data present on the tag 802). In particular, each RFID tag 802 is typically able to have new data written while coupled to the consumable component 822 during torch operation, consumable removal and/or consumable installation.

The material processing system 800 can also include at least one RFID reader 808 configured to read information stored in one or more of the RFID tags 820 of the material processing system 800. In some embodiments, an RFID reader 808 is attached to each consumable exchanger 802, such as to any one of the holder 834, the base portion 832 or the driver 830 of the exchanger 802. In alternative embodiments, an RFID reader 808 is located external to the exchanger 802, such as on a handheld device that can be held by an operator close to an RFID tag 820 to read the information stored on the tag. In this case, because the RFID reader 808 is mobile, fewer RFID readers are needed by the system 800 to extract data from the RFID tags 820. Each RFID reader 808 is adapted to extract data conveyed by an RFID tag 820 and transmit the data about the consumable component 822 corresponding to the tag 820 to the central controller 806 for performance analysis and further action. In some embodiments, each RFID reader 808 is also a data writing device that is configured to write data to a rewritable RFID tag 820. An RFID reader 808 can communicate data to and receive data from the controller 806 via the network 810, either wirelessly or through a wired connection. In the case of data reception by the RFID reader 808, the reader 808 can write the received data to an RFID tag 820 that is in signal communication with the reader 808.

In general, the central controller 806 can automatically track the performance characteristics, usage history and locations of the consumable components 822 in the system 800 based on the data stored on the RFID tag 820 of each of the consumable components 822. Based on such information, the central controller 806 can intelligently select a suitable consumable component from the multiple consumable components 822 in the system 800 for installation onto a plasma arc torch to perform a desired torch operation while optimizing overall performance and efficiency. For example, the central controller 806 can decide to change out consumable components for a particular torch between tasks, such as choosing a comparatively new set of consumables for the torch to perform a high-precision cut and then changing to a older (i.e., less precise) set of consumables for a rougher cut.

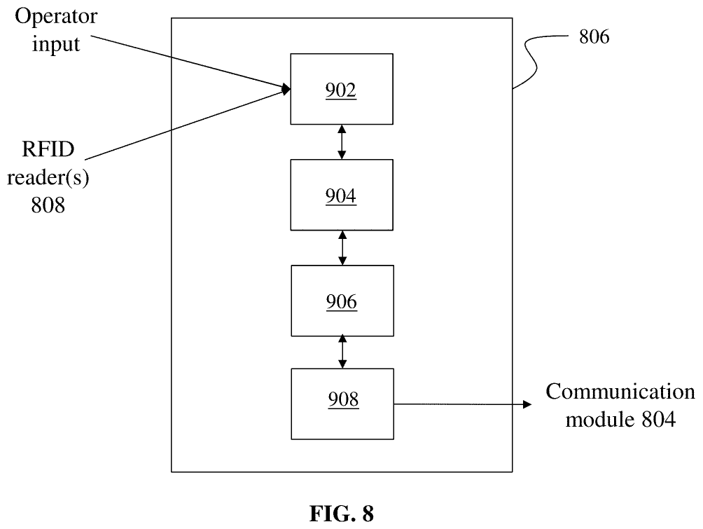

FIG. 8 shows an exemplary configuration of the central controller 806 of the material processing system 800 of FIG. 7, according to some embodiments of the present invention. The central controller 806 can be a computing device in the form of a digital signal processor (DSP), microprocessor, microcontroller, computer, computer numeric controller (CNC) machine tool, programmable logic controller (PLC), application-specific integrated circuit (ASIC), or the like. The central controller 806 can be located on a power and/or gas supply (not shown) of the system 800 or at another remote location. In general, the central controller 806 includes specialized hardware and/or software modules executable on a processor to receive data from other components of the material processing system 800, transmit data to other components of the material processing system 800, and perform functions related to providing centralized control and coordination of consumable installation and removal for plasma arc torches as described herein. The central controller 806 includes several computing modules 902, 904, 906, 908 that execute on the processor of the central controller 806. In some embodiments, the modules 902, 904, 906, 908 are specialized sets of computer software instructions programmed onto one or more dedicated processors in the controller 806 and can include specifically designated memory locations and/or registers for executing the specialized computer software instructions.

Although the modules 902, 904, 906, 908 are shown in FIG. 8 as executing within the same computing device of the central controller 806, in some embodiments the functionality of the modules 902, 904, 906, 908 are distributed among a plurality of computing devices. Further, the central controller 806 enables the modules 902, 904, 906, 908 to communicate with each other to exchange data for performing the described functions. It should be appreciated that any number of computing devices, arranged in a variety of architectures, resources, and configurations (e.g., cluster computing, virtual computing, cloud computing) can be used without departing from the scope of the invention. The exemplary functionalities of the modules 902, 904, 906, 908 are described in detail below.

The input module 902 of the controller 806 is generally configured to receive, from an operator, data related to a desired processing operation, such as the type of operation desired (e.g., cutting, marking or gouging), the material to be processed, and the duration of the operation. The input module 902 is also configured to receive information from the one or more RFID readers 808 about the performance characteristics of the consumable components 822 in the material processing system 800. As described above in detail, an RFID reader 808 can extract such information from the one or more RFID tags 820 coupled to the respective ones of the consumable components 822 in the system 800 throughout the lifetime of each consumable component 822.

The input module 902 is in signal communication with the decision module 904 of the controller 806, which is configured to select a suitable consumable component from the multiple consumable components 822 in the system 800 for carrying out the desired processing operation received by the input module 902. The selection by the decision module 904 can be based on the suitable consumable component having a performance characteristic compatible with the desired operation. For example, selection by the decision module 904 can be based on evaluating the performance characteristics of the suitable consumable component (e.g., implementing a counter to track the number of contact starts by the consumable component) and determining whether it has sufficient life remaining (e.g., the sufficient number of contact starts remaining) to perform the desired operation.

The decision module 904 is in signal communication with the locator module 906 of the controller 806, which is configured to locate a suitable consumable component selected by the decision module 904 for installation on the torch. Additionally, the locator module 906 is configured to position the torch and the suitable consumable component for engagement with each other. For example, if the torch already has the same (but unsuitable) type of consumable component installed, the locator module 906 can automatically move the torch to an exchanger 802 of the system 800 to remove the unsuitable consumable component from the torch prior to installation of the suitable consumable component. As another example, if the suitable consumable component is currently installed in another (but unsuitable) torch, the locator module 906 can automatically move the unsuitable torch to an exchanger 802 of the system 800 to remove the suitable consumable component, thereby making it available for installation onto the preferred torch. Further, the locator module 906 can translate the torch to the exchanger 802 with the suitable consumable component pre-loaded therein such that the torch is positioned above and aligned with the exchanger 802 in the vertical direction prior to installation.

The locator module 906 is in signal communication with the actuation module 908 of the controller 806, which is configured to actuate the exchanger 802 having the suitable consumable component pre-loaded therein to initiate installation of the consumable component onto the tip of the torch positioned above the exchanger 802. In some embodiments, the locator module 906 transmits a signal to the actuation module 908 once all the pieces for installation are in position and ready for installation. The actuation module 908 can in turn transmit a signal to the communication module 804 attached to the appropriate exchanger 802 via the communication network 810 to signal initiation of an installation routine. Once actuated, the communication module 804 of the exchanger 802, in cooperation with the driver 830 of the exchanger initiates rotation of the holder 834 to install the pre-loaded consumable component onto the tip of the torch using any one of the engagement mechanisms described above. In some embodiments, the actuation module 908 initiates rotation of an exchanger 802 to commence an installation operation if a consumable sensing switch of the torch is triggered when the torch is sufficiently lowered toward the consumable component with a raised portion that activates (e.g., depresses) the consumable sensing switch. In some embodiments, the actuation module 908 initiates rotation of an exchanger 802 to commence a removal operation if a local sensor (e.g., the local detector 113 of FIG. 1) is triggered, after analyzing data transmitted from the RFID tag associated with the consumable component to be removed, and/or by verifying the location of the torch in relation to the exchanger.

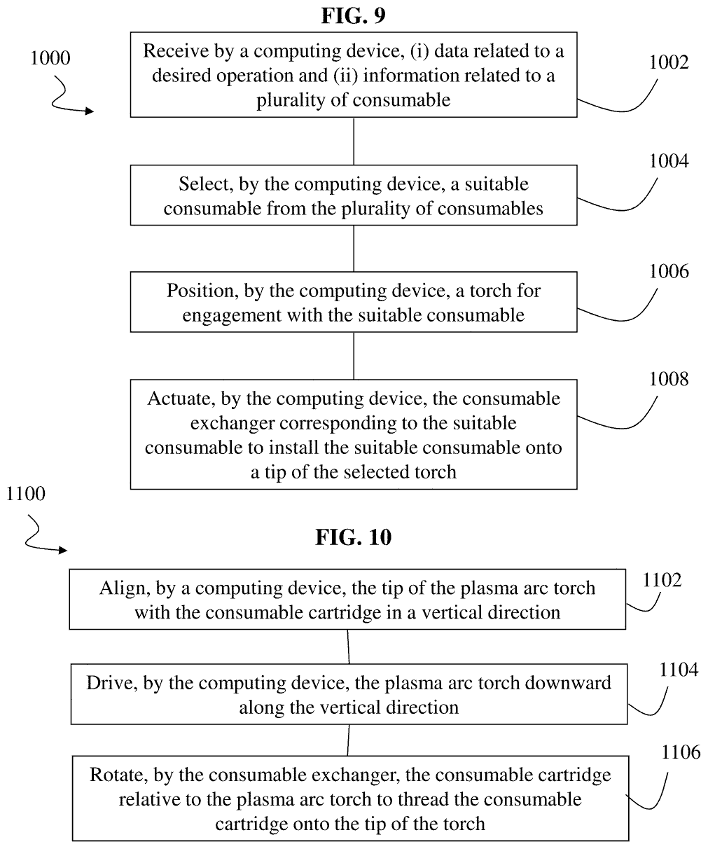

FIG. 9 shows an exemplary process 1000 executable by the central controller 806 of FIG. 8 for initiating automatic installation of a consumable component onto the tip of a plasma arc torch within the material processing system 800 of FIG. 7, according to some embodiments of the present invention. The process starts when the central controller 806 receives, via the input module 902, data related to a desired operation (step 1002). The central controller 802 is also configured to receive and track information related to various consumable components (e.g., individual consumable parts or cartridges) in the system 800, including one or more performance characteristics of each consumable component. Such information can be conveyed, for example, by an RFID tag associated with the consumable component or tracking of the consumable component by the controller 806, where the RFID tag is adapted to transmit to the controller 806 information about the consumable component throughout the life cycle of the component. In general, each consumable component can be located anywhere in the system 800, such as disposed in a consumable exchanger ready for installation or already installed on a torch that is in operation or idle. The decision module 904 of the controller 806 is adapted to select a suitable consumable component, from all the consumable components in the system 800, for use in the desired operation, by matching characteristics of the desired operation with characteristics of the consumables (step 1004). For example, the decision module 904 can choose a consumable that has sufficient life remaining to complete the desired operation. The locator module 906 of the controller 806 then locates an available torch for engagement with the suitable consumable component (step 1006). Specifically, the locator module 906 can prepare and position the torch and the consumable component to ensure that both are ready for installation with one another, where the consumable component is loaded in an exchanger and the torch is positioned above the exchanger. Such positioning is described below in detail in relation to FIG. 10. The actuation module 908 of the controller 806 then instructs the exchanger with the suitable consumable component loaded therein to initiate rotation of the consumable component to install the consumable component onto the tip of the torch (step 1008). For example, the actuation module 908 can send a signal to the exchanger to start rotation as well as indicate the direction and duration of rotation.

FIG. 10 shows an exemplary process 1100 by a consumable exchanger of the present invention, such as the installation exchanger 104 or the integrated exchanger 602, for installing a consumable cartridge onto a tip of a plasma arc torch in a material processing system with automated consumable exchanging capabilities (e.g., the system 800), according to some embodiments of the present invention. The process starts when the central controller 806, such as the locator module 906 of the controller 806, instructs a plasma arc torch to be moved adjacent to an exchanger that has a desired consumable cartridge preloaded in and retained by the holder of the exchanger, so that the tip of the plasma arc torch is aligned with the consumable cartridge in the exchanger (step 1102). The movement of the plasma arc torch can include translating the torch in a lateral (x-y) plane to be closer to the exchanger. Further, the controller 806 can instruct the plasma arc torch to be lowered in a vertical (z) direction 120 downward relative to the exchanger after the torch and the exchanger are aligned (step 1104). Optionally, the process can also comprise the central controller 806, such as the locator module 906 of the controller, instructing the exchanger to be moved adjacent to the torch. The movement of the exchanger includes one or more of translating the exchanger in the lateral plane and raising the exchanger in the vertical direction upward relative to the torch. In general, the controller 806 can cause one or both of the torch and the exchanger to move, in either the lateral plane or the vertical direction, relative to each other to align the torch tip with the consumable cartridge in the exchanger in preparation for installation. After the torch and the consumable cartridge of the exchanger are suitably positioned relative to each other, the consumable exchanger can rotate the consumable cartridge and/or the holder (and in turn the consumable cartridge retained by the holder) relative to the torch to thread the cartridge onto the tip of the torch (step 1106). In some embodiments, the initiation of rotation by the exchanger is decided by the central controller 806, such as by the actuation module 908 of the controller 806, as described above with respect to FIG. 8. In some embodiments, the initiation of rotation by the exchanger is triggered by the exchanger itself, such as based on detection of the proximity of the torch or the consumable component by a detector located in or on the exchanger, as described above with respect to FIG. 1.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites. The computer program can be deployed in a cloud computing environment (e.g., Amazon® AWS, Microsoft® Azure, IBM®).

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, near field communications (NFC) network, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Within the context of the present invention, the term “about” in relation to a particular degree value can be constructed as covering a range of ±four-degree deviation from the particular degree value. It should be understood that various aspects and embodiments of the invention can be combined in various ways. Based on the teachings of this specification, a person of ordinary skill in the art can readily determine how to combine these various embodiments. Modifications may also occur to those skilled in the art upon reading the specification.

What is claimed is:

1. A consumable exchanger for a plasma arc material processing system, the consumable exchanger comprising:
a base portion;
a holder shaped to retain at least a portion of a consumable component of a plasma arc torch, the holder operably connected to the base portion; and
a driver connected to the holder, the driver configured to rotate the consumable component relative to at least one of the base portion or the plasma arc torch to perform one of engage the consumable component to the plasma arc torch or disengage the consumable component from the plasma arc torch.

2. The consumable exchanger of claim 1, wherein the holder is shaped to retain a distal end of the consumable component.

3. The consumable exchanger of claim 1, wherein the base portion is configured to be attached to a material processing table.

4. The consumable exchanger of claim 1, wherein the consumable component is a cartridge that encapsulates two or more individual plasma arc torch consumables.

5. The consumable exchanger of claim 1, wherein the consumable component is air cooled.

6. The consumable exchanger of claim 1, wherein the driver is substantially pneumatic such that rotation by the driver is activated by a gas flow.

7. The consumable exchanger of claim 1, wherein the driver is substantially electrical such that rotation by the driver is powered by electrical energy.

8. The consumable exchanger of claim 1, wherein a rotation of the driver is no more than about 180 degrees to engage or disengage the consumable component.

9. The consumable exchanger of claim 1, further comprising a detector operably connected to the driver to detect a presence of the consumable component in the holder prior to rotation.

10. The consumable exchanger of claim 9, wherein the driver is adapted to rotate in a first direction to engage the consumable component to the torch if the detector detects the consumable component in the holder prior to the rotation, and wherein the driver is adapted to rotate in a second direction opposite of the first direction to disengage the consumable component from the torch if the detector does not detect the consumable component in the holder prior to the rotation.

11. The consumable exchanger of claim 1, further comprising a communication module in electrical communication with a controller of the material processing system, the driver is adapted to rotate in a first direction to engage the consumable component to the torch or in a second direction opposite of the first direction to disengage the consumable component from the torch based on instructions received from the controller via the communication module.

12. The consumable exchanger of claim 11, further comprising a reader configured to read information stored in a radio-frequency identification (RFID) tag coupled to the consumable component, the information comprising a life characteristic of the consumable component.

13. The consumable exchanger of claim 12, wherein the reader is configured to transmit the life characteristic of the consumable component to the controller of the material processing system.

14. The consumable exchanger of claim 13, wherein the reader is coupled to the holder.

15. The consumable exchanger of claim 1, wherein the holder comprises a cup or a gripper with a plurality of claws.

16. The consumable exchanger of claim 1, wherein the holder comprises an interface with at least one keyed feature configured to matingly engage a complementary keyed feature of the consumable component for retaining the consumable component during the engagement or disengagement.

17. A computer-implemented method for automatically installing a consumable to a tip of a plasma arc torch that is operably connected to a plasma cutting system, the method comprising:
receiving, by a computing device, (i) data related to a desired operation and (ii) information related to a plurality of consumables, including a performance characteristic of each consumable, wherein the plurality of consumables are disposed in respective ones of a plurality of consumable exchangers;
selecting, by the computing device, a suitable consumable from the plurality of consumables, the suitable consumable having a performance characteristic compatible with the desired operation;
positioning, by the computing device, a torch for engagement with the suitable consumable; and
actuating, by the computing device, the consumable exchanger corresponding to the suitable consumable to install the suitable consumable onto a tip of the torch.

18. The method of claim 17, wherein each consumable comprises a cartridge encapsulating a plurality of individual consumable components.

19. The method of claim 17, further comprising, actuating, by the computing device, a separate consumable exchanger to remove an unsuitable consumable from the torch prior to actuating the consumable exchanger to install the suitable consumable onto the torch.

20. The method of claim 17, wherein selecting the suitable consumable comprises the computing device determining that the suitable consumable has sufficient remaining life to perform the desired operation based on the performance characteristic of the suitable consumable.

21. The method of claim 17, further comprising rotating, by the consumable exchanger, the suitable consumable onto the tip of the torch to install the suitable consumable.

22. The method of claim 17, wherein the computing device receives the information related to each of the plurality of consumables from a radio-frequency identification (RFID) tag attached to each consumable.

23. The method of claim 22, further comprising:
automatically reading, by at least one RFID reader, the information related to the plurality of consumables from the RFID tags attached to the corresponding ones of the plurality of consumables; and
transmitting, by the at least one RFID reader, the information to the computing device.

24. The method of claim 23, wherein the at least one RFID reader is a handheld reader.

25. The method of claim 23, wherein the at least one RFID reader comprises a plurality of RFID readers coupled to corresponding ones of the plurality of consumable exchangers.

26. The method of claim 17, wherein the computing device is configured to centrally coordinate the automatic installation of the consumable onto the tip of the plasma arc torch without receiving a direction from the plurality of consumable exchanger.

27. A material processing system comprising:
a plurality of consumable exchangers each comprising a holder shaped to retain and install a consumable; and
a computing device in electrical communication with the plurality of consumable exchangers, the computing device comprising:
an input module configured to receive (i) data related to a desired operation and (ii) information related to a plurality of possible consumables, including a performance characteristic of each possible consumable, wherein the plurality of possible consumables are disposed in respective ones of the plurality of consumable exchangers;
a decision module configured to select a suitable consumable from the plurality of possible consumables, the suitable consumable having a performance characteristic compatible with the desired operation;
a torch locator configured to select a torch for engagement with the suitable consumable; and
an actuation module configured to instruct the consumable exchanger corresponding to the suitable consumable to install the suitable consumable onto a tip of the selected torch.

28. The material processing system of claim 27, further comprising a plurality of RFID tags coupled to corresponding ones of the possible consumables, the plurality of RFID tags configured to store the performance characteristics of the respective possible consumables.

29. The material processing system of claim 28, further comprising at least one RFID reader configured to read the performance characteristics from the RFID tags and transmit the performance characteristics to the input module.

30. A method for installing a consumable cartridge onto a tip of a plasma arc torch in a plasma cutting system, the consumable cartridge including at least an electrode and a swirl ring, the method comprising:
loading the consumable cartridge in a holder of a consumable exchanger, wherein the holder is configured to retain at least a portion of the consumable cartridge;
aligning, by a computing device, the tip of the plasma arc torch with the consumable cartridge in the consumable exchanger to achieve an aligned position;
driving, by the computing device, the plasma arc torch downward along a vertical direction toward the consumable cartridge in the aligned position; and
rotating, by the consumable exchanger, the consumable cartridge relative to the plasma arc torch to thread the consumable cartridge onto the tip of the torch.

31. The method of claim 30, further comprising moving, by the consumable exchanger, the consumable cartridge upward along the vertical direction during the rotation to thread the consumable cartridge onto the tip of the torch.

32. The method of claim 30, wherein the driving of the plasma arc torch downward initiates translation of the consumable exchanger in a lateral plane to position the consumable exchanger under the plasma arc torch.

33. The method of claim 30, wherein the consumable exchanger retains the at least a portion of the consumable cartridge via a keyed interface comprising a keyed feature of the consumable exchanger matingly engaging a corresponding keyed feature of the consumable cartridge.

34. The method of claim 33, wherein the consumable exchanger includes an even number of keyed features that are located symmetrically around a circumference of the consumable exchanger.

35. The method of claim 34, further comprising applying, by the consumable exchanger, a torque substantially evenly around a circumference of the consumable cartridge during the rotation to thread the consumable cartridge onto the tip of the plasma arc torch.
